(19) United States
(12) Patent Application Publication
(10) Pub. No.: US 2015/0171977 A1
(43) Pub. Date: Jun. 18, 2015

(54) ELECTRONIC APPARATUS AND PROCESSING METHOD OF AN ELECTRONIC APPARATUS

(71) Applicant: Kabushiki Kaisha Toshiba, Tokyo (JP)

(72) Inventor: Ippei Kashiwagi, Ome-shi (JP)

(21) Appl. No.: 14/341,712

(22) Filed: Jul. 25, 2014

(30) Foreign Application Priority Data
Dec. 16, 2013 (JP) 2013-259260

(51) Int. Cl. H04B 17/00; H01Q 3/02; H01Q 3/24

(52) U.S. Cl. CPC H04B 17/0057; H01Q 3/24; H01Q 3/02

(57) ABSTRACT

According to one embodiment, an electronic apparatus includes an antenna module, a wireless communicator, an acquisition module and an adjuster. The wireless communicator is configured to wirelessly communicate via the antenna module. The acquisition module is configured to acquire signal strength of a radio signal received by the antenna module from the wireless communicator. The adjuster is configured to adjust a position of an antenna of the antenna module based on the signal strength of the radio signal acquired by the acquisition module.

### CROSS-REFERENCE TO RELATED APPLICATIONS

This application is based upon and claims the benefit of priority from Japanese Patent Application No. 2013-259260, filed Dec. 16, 2013, the entire contents of which are incorporated herein by reference.

### FIELD

Embodiments described herein relate generally to antenna position adjustment technology suitable for, for example, an electronic apparatus equipped with a function to detect a moving person and object (moving object) by monitoring variation of a radio signal.

### BACKGROUND

As systems for detecting the intrusion of a suspicious individual, a system of detecting the blocking of infrared rays and a system of detecting the blocking or reflection of microwaves are known.

Such systems of detecting the blocking of infrared rays or detecting the blocking or reflection of microwaves have a problem in that the area being monitored is limited by, for example, the directional characteristics of an antenna, which creates blind spots.

For this reason, a system of detecting the variation of signal strength of a radio signal for wireless communication has been currently under consideration since such a system spreads radio waves (carrier waves) over the entire interior area being monitored by reflection. Therefore, a mechanism for detecting variation of signal strength of a radio signal in an indoor environment with a high degree of accuracy is needed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram for illustrating a principle of moving object detection by an electronic apparatus according to an embodiment.

FIG. 2 is an exemplary diagram showing a function block regarding the moving object detection of the electronic apparatus according to the embodiment.

FIG. 3 is an exemplary diagram showing structural examples of an antenna module of the electronic apparatus according to the embodiment.

FIG. 4 is an exemplary chart showing an example in which a radio wave (carrier wave) causes antinodes and nodes of a standing wave to be generated by superposition of reflected waves in an indoor environment.

FIG. 5 is an exemplary chart showing an example of a simulation of variation of signal strength (variation of a reception level) predicted to be observed when a moving object is present in the indoor environment.

FIG. 6 is an exemplary flowchart showing a first procedure of antenna position adjustment executed by the electronic apparatus according to the embodiment.

FIG. 7 is an exemplary flowchart showing a second procedure of the antenna position adjustment executed by the electronic apparatus according to the embodiment.

### DETAILED DESCRIPTION

Various embodiments will be described hereinafter with reference to the accompanying drawings.

In general, according to one embodiment, an electronic apparatus includes an antenna module, a wireless communicator, an acquisition module and an adjuster. The wireless communicator is configured to wirelessly communicate via the antenna module. The acquisition module is configured to acquire signal strength of a radio signal received by the antenna module from the wireless communicator. The adjuster is configured to adjust a position of an antenna of the antenna module based on the signal strength of the radio signal acquired by the acquisition module.

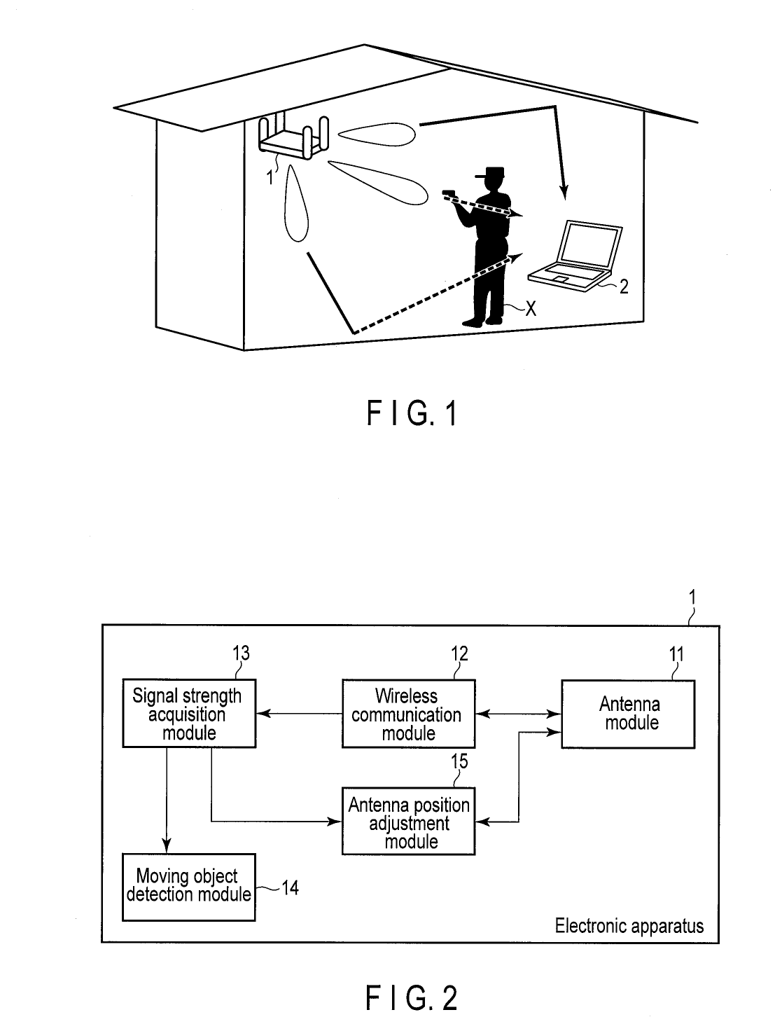

FIG. 1 is an exemplary diagram for illustrating a principle of moving object detection by an electronic apparatus 1 of the present embodiment. The electronic apparatus 1 includes a wireless communication function to execute wireless communication conforming to, for example, the IEEE 802.11g standard, and detects a moving object x which is an intruder based on a situation of wireless communication with the other wireless communication device. It is assumed that the electronic apparatus 1 is implemented as a router which functions as an access point of a wireless LAN. It is also assumed that a personal computer 2 exists as the other wireless communication device, and that the electronic apparatus 1 detects the moving object x as an intruder based on a situation of wireless communication with the personal computer 2.

The electronic apparatus 1 operates as the access point of the wireless LAN when a user is at home, and operates as a sensor for detecting an intruder when the user is absent. That is, the electronic apparatus 1 is not structured as a device dedicated to intruder detection, but includes a function to detect an intruder (moving object) in addition to a function to connect the other wireless communication device including the personal computer 2 to the wireless LAN. When the user goes out, the user activates the function of the electronic apparatus 1 to detect an intruder by an operation on the personal computer 2. Of course, the electronic apparatus 1 can also be structured as a device dedicated to intruder detection.

When the function to detect an intruder is activated and the electronic apparatus 1 and the personal computer 2 are connected wirelessly, radio waves in a microwave band for carrying radio signals are radiated in various directions by reflected waves in an indoor environment as shown in FIG. 1. If the moving object x which is an intruder appears in this situation, a reception level of the radio waves in the electronic apparatus 1 and the personal computer 2 is varied by the moving object x coming across the waves. The electronic apparatus 1 detects the moving object x which is an intruder by utilizing this phenomenon. The electronic apparatus 1 implements a mechanism for detecting the variation of the reception level with a high degree of accuracy, which will be hereinafter described in detail. Operations executed when the moving object x which is an intruder is detected are not described here.

FIG. 2 is an exemplary diagram showing a function block regarding the moving object detection of the electronic apparatus 1.

As shown in FIG. 2, the electronic apparatus 1 includes an antenna module 11, a wireless communication module 12, a signal strength acquisition module 13, a moving object detection module 14 and an antenna position adjustment module 15.

As described above, the electronic apparatus includes the wireless communication function to execute wireless communication conforming to, for example, the IEEE 802.11g standard. The wireless communication module 12 is a device configured to control execution of this wireless communication. The antenna module 11 is a device configured to emit and pick up the radio waves in the microwave band (for example, waves in the 2.40-GHz band) in order to transmit and receive data.

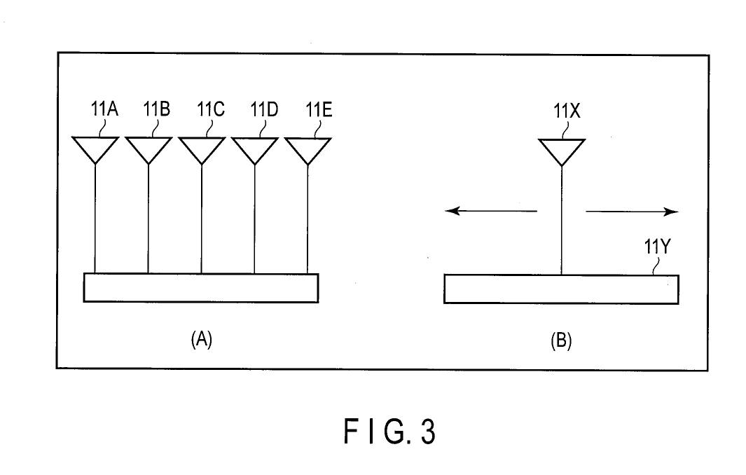

The antenna module 11 is structured such that a position of an antenna (at least, a receiving antenna) can be changed. FIG. 3 shows a structural example of the antenna module 11.

In FIG. 3, (A) is an exemplary diagram showing a first structural example of the antenna module 11. The first structural example of the antenna module 11 includes a plurality of antennas 11A to 11E, and can change positions of the antennas by selecting any of the antennas.

(B) is an exemplary diagram showing a second structural example of the antenna module 11. The second structural example of the antenna module 11 can change the position of an antenna 11X by including a drive mechanism 11Y configured to move the position of the antenna 11X.

The electronic apparatus 1 is configured to adjust the positions of the antennas based on its own principle. A method of structuring the antenna module 11 such that the position of the antenna can be changed is not limited to this, but any other method can be applied.

FIG. 2 will be referred to again.

The signal strength acquisition module 13 is a module configured to acquire signal strength (received signal strength indicator [RSSI]) of radio signals received by the antenna module 11 from the wireless communication module 12. The moving object detection module 14 is a module configured to monitor the signal strength acquired by the signal strength acquisition module 13 and to detect the moving object x based on the variation of the signal strength. The antenna position adjustment module 15 is a module configured to adjust the positions of the antennas (in particular, the receiving antenna) of the antenna module 11 based on the signal strength acquired by the signal strength acquisition module 13 such that the variation of the signal strength is detected by the moving object detection module 14 with a high degree of accuracy. A principle of adjusting the antenna positions by the antenna position adjustment module 15 will be described.

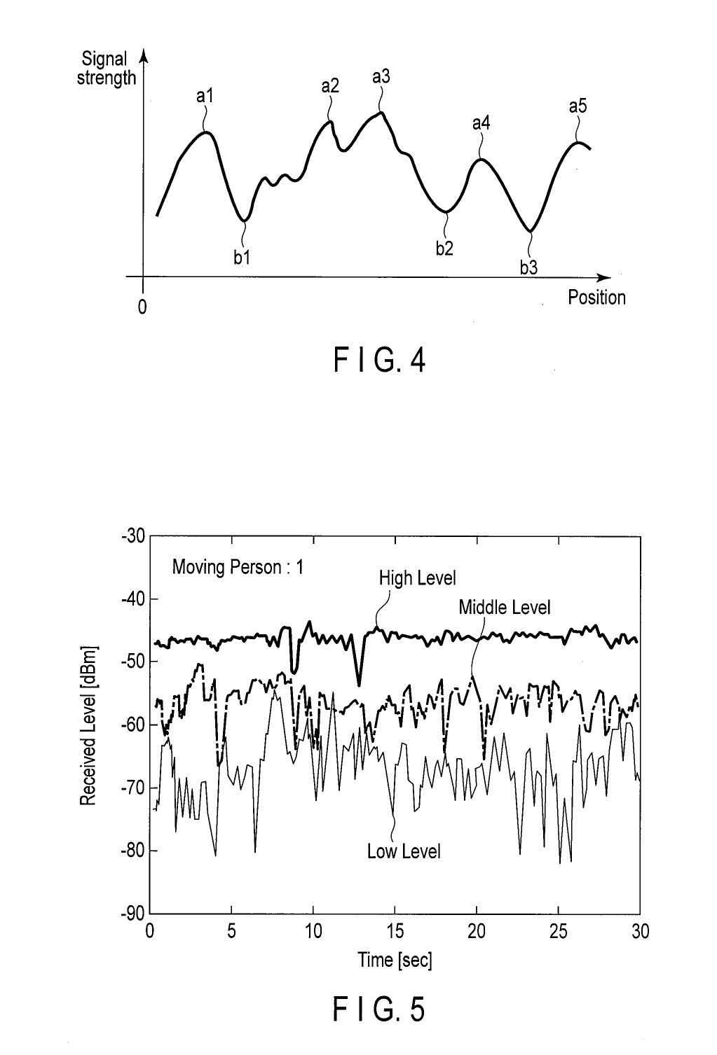

FIG. 4 is an exemplary chart showing an example in which a radio wave (carrier wave) causes antinodes and nodes of a standing wave to be generated by superposition of reflected waves in the indoor environment. In FIG. 4, reference numerals a1, a2, a3, a4 and a5 denote portions called antinodes of the standing wave, and reference numerals b1, b2 and b3 denote portions called nodes of the standing wave.

FIG. 5 is an exemplary chart showing an example of a simulation of the variation of the signal strength predicted to be observed when the moving object x (a moving person) is present in the indoor environment. FIG. 5 shows three simulation results, i.e., a case where a reception level is high, a case where the reception level is medium, and a case where the reception level is low.

As shown in FIG. 5, it is found that the variation of the signal strength caused by the moving object x becomes greater as the reception level becomes lower. Therefore, if the antenna is arranged at a position which is to be a node of the standing wave shown in FIG. 4, even a small variation occurring along with movement of a human body is observed as a great level variation, and intrusion of the moving object x, i.e., a suspicious individual can be detected with a good sensitivity.

The position which is to be a node of the standing wave is a particular position in which a number of reflected waves are superposed and the reception level is low. Therefore, the balance can be easily lost and the level variation is likely to be more apparent if a human body merely comes across and blocks one of the reflected waves.

The electronic apparatus 1 includes a timer function. When the function of the electronic apparatus 1 to detect an intruder is activated by the user, the antenna position adjustment module 15 starts adjustment processing for arranging the antenna of the antenna module 11 in the position which is to be a node of the standing wave by using the timer function after a set period, in order to adjust the positions of the antennas in a state in which the user moves outside and the moving object x is not present indoors. The electronic apparatus 1 can thereby avoid unnecessary intrusion detection and executes secure calibration (position adjustment of antennas).

If the structure of the antenna module 11 is the first structural example shown in (A) of FIG. 3, the antenna position adjustment module 15 turns on the antennas one by one such that any one of the plurality of antennas 11A to 11E is turned on. At this time, the antenna position adjustment module 15 acquires the signal strength acquired by the signal strength acquisition module 13 with respect to each of the plurality of antennas 11A to 11E. Then, the antenna position adjustment module 15 selects one of the plurality of antennas 11A to 11E that has the least signal strength acquired by the signal strength acquisition module 13, and turns on the selected antenna.

If the structure of the antenna module 11 is the second structural example shown in (B) of FIG. 3, the antenna position adjustment module 15 first moves the antenna 11X to the start point of a drivable range of the antenna 11X through the drive mechanism 11Y. Then, the antenna position adjustment module 15 moves the antenna 11X to the end point of the drivable range of the antenna 11X by a predetermined width through the drive mechanism 11Y. At this time, the antenna position adjustment module 15 acquires the signal strength acquired by the signal strength acquisition module 13 with respect to each destination (including the start point and the end point of the drivable range) of the antenna 11X. The antenna position adjustment module 15 arranges the antenna 11X through the drive mechanism 11Y in a position which has the least signal strength acquired by the signal strength acquisition module 13.

An example of executing the search (of the position having the least signal strength) from the start point to the end point of the drivable range of the antenna 11X is described here. However, at the time of detecting a position in which the signal strength is lower than a predetermined threshold, this position may be determined to be a position of the antenna 11X and the search may be completed. The threshold is set to an upper limit at which the variation occurring along with the movement of a human body is observed as a great level variation.

As described above, the electronic apparatus 1 detects the variation of signal strength of the radio signals in the indoor environment with a high degree of accuracy, i.e., detects intrusion of a suspicious individual with a good sensitivity, by the antenna module 11 configured to change the position of the antenna and the antenna position adjustment module 15 configured to adjust the position of the antenna of the antenna module 11 at a position which is to be a node of the standing wave.

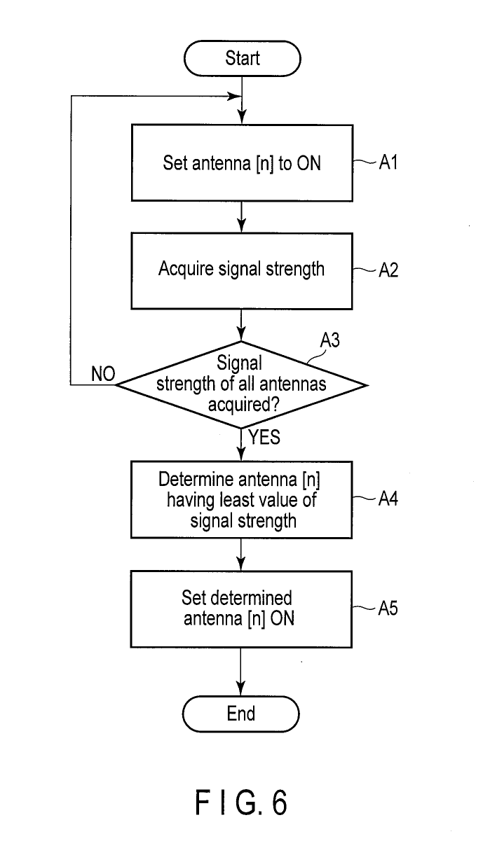

FIG. 6 is an exemplary flowchart showing a procedure of the antenna position adjustment executed by the electronic apparatus 1 in a case where the structure of the antenna module 11 is the first structural example shown in (A) of FIG. 3.

The antenna position adjustment module 15 turns on any one of the plurality of antennas 11A to 11E (block A), and acquires the signal strength acquired by the signal strength acquisition module 13 (block A2). In this procedure, antenna position adjustment module 15 acquires the signal strength acquired by the signal strength acquisition module 13 with respect to all of the plurality of antennas 11A to 11E (NO of block A3, A1 and A2).

When the signal strength of all of the antennas is acquired (YES of block A3), the antenna position adjustment module 15 determines which antenna of the plurality of antennas 11A to 11E has the least signal strength acquired by the signal strength acquisition module 13 (block A4). Then, the antenna position adjustment module 15 turns on the determined antenna (block A5).

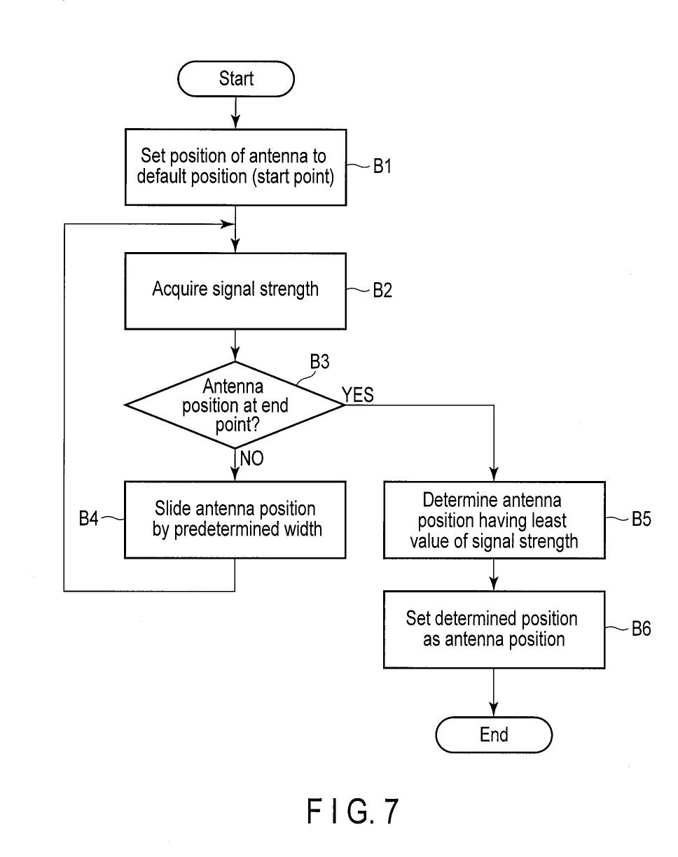

FIG. 7 is an exemplary flowchart showing a procedure of antenna position adjustment executed by the electronic apparatus 1 in a case where the structure of the antenna module 11 is the second structural example shown in (B) of FIG. 3.

First, the antenna position adjustment module 15 sets a position of the antenna 11X to a default position (the start point of the drivable range) through the drive mechanism 11Y (block B1), and acquire the signal strength acquired by the signal strength acquisition module 13 (block B2). The antenna position adjustment module 15 acquires the signal strength acquired by the signal strength acquisition module 13 while moving the antenna 11X to the end point of the drivable range by a predetermined width (NO of block B3, B4 and B2).

When the antenna 11X is moved up to the end point of the drivable range (YES of block B3), the antenna position adjustment module 15 determines a position in which the least signal strength is acquired (block B5), and sets the determined position as a position of the antenna (block B6).

As described above, the electronic apparatus 1 can implement the antenna position adjustment for detecting the variation of the signal strength of the radio signals in the indoor environment with a high degree of accuracy.

An example in which the electronic apparatus 1 is equipped with the moving object detection module 14 configured to detect the moving object x based on the variation of the signal strength of the radio signals received by the antenna module 11 is described here. However, the signal strength acquired by the signal strength acquisition module 13 may be transmitted to, for example, a server on the Internet by, for example, wireless communication via the wireless communication module 12, such that the moving object x is detected based on the variation of the signal strength of the radio signals on the server. The server can provide a service such as sending an email to a predetermined address to provide notification of the detection of the moving object x.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an antenna module;
a wireless communicator configured to wirelessly communicate via the antenna module;
an acquisition module configured to acquire signal strength of a radio signal received by the antenna module from the wireless communicator; and
an adjuster configured to adjust a position of an antenna of the antenna module based on the signal strength of the radio signal acquired by the acquisition module.

2. The apparatus of claim 1, wherein:
the antenna module comprises a plurality of antennas; and
the adjuster is configured to adjust the position of the antenna by selecting an antenna which has the least value of the signal strength of the radio signal acquired by the acquisition module from the plurality of antennas.

3. The apparatus of claim 2, further comprising a detector configured to detect a moving object around the apparatus based on variation of the signal strength of the radio signal acquired by the acquisition module.

4. The apparatus of claim 3, further comprising a receiver configured to receive an actuation instruction of moving object detection,
wherein the adjuster is configured to execute the position adjustment of the antenna of the antenna module when a first period is passed after the reception of actuation instruction of the moving object detection by the receiver.

5. The apparatus of claim 2, further comprising a transmitter configured to transmit information comprising a value of the signal strength of the radio signal acquired by the acquisition module via the wireless communication by the wireless communicator.

6. The apparatus of claim 1, wherein:
the antenna module comprises a driver configured to move the position of the antenna; and
the adjuster is configured to adjust the position of the antenna of the antenna module by arranging the antenna at a position in which a value of the signal strength of the radio signal acquired by the acquisition module is lower than a threshold, by the driver.

7. The apparatus of claim 6, wherein the adjuster is configured to arrange the antenna in a position which has the least value of the signal strength of the radio signal acquired by the acquisition module.

8. The apparatus of claim 6, further comprising a detector configured to detect a moving object around the apparatus based on variation of the signal strength of the radio signal acquired by the acquisition module.

9. The apparatus of claim 8, further comprising a receiver configured to receive an actuation instruction of moving object detection,
wherein the adjuster is configured to execute position adjustment of the antenna of the antenna module when a first period is passed after the reception of the actuation instruction of the moving object detection by the receiver.

10. The apparatus of claim 6, further comprising a transmitter configured to transmit information comprising a value of the signal strength of the radio signal acquired by the acquisition module via the wireless communication by the wireless communicator.

11. A processing method of an electronic apparatus, the method comprising:
acquiring signal strength of a radio signal received by an antenna module from a wireless communicator configured to wirelessly communicate via the antenna module; and
adjusting a position of an antenna of the antenna module based on the acquired signal strength of the radio signal.

12. The method of claim 11, wherein:
the antenna module comprises a plurality of antennas; and
the adjusting comprises adjusting the position of the antenna by selecting an antenna which has the least value of the acquired signal strength of the radio signal from the plurality of antennas.

13. The method of claim 12, further comprising detecting a moving object around the apparatus based on variation of the acquired signal strength of the radio signal.

14. The method of claim 13, further comprising receiving an actuation instruction of moving object detection,
wherein the adjusting comprises executing position adjustment of the antenna of the antenna module when a first period is passed after the receiving the actuation instruction of the moving object detection.

15. The method of claim 12, further comprising transmitting information comprising a value of the acquired signal strength of the radio signal via the wireless communication by the wireless communicator.

16. The method of claim 11, wherein:
the antenna module comprises a driver configured to move the position of the antenna; and
the adjusting comprising adjusting the position of the antenna of the antenna module by arranging the antenna at a position in which a value of the acquired signal strength of the radio signal is lower than a threshold, by the driver.

17. The method of claim 16, wherein the adjusting comprises arranging the antenna in a position which has the least value of the acquired signal strength of the radio signal.

18. The method of claim 16, further comprising detecting a moving object around the apparatus based on variation of the acquired signal strength of the radio signal.

19. The method of claim 18, further comprising receiving an actuation instruction of moving object detection,
wherein the adjusting comprises executing position adjustment of the antenna of the antenna module when a first period is passed after the receiving the actuation instruction of the moving object detection.

20. The method of claim 16, further comprising transmitting information comprising a value of the acquired signal strength of the radio signal via the wireless communication by the wireless communicator.
